(19) United States
(12) Patent Application Publication
(10) Pub. No.: US 2019/0313831 A1
(43) Pub. Date: Oct. 17, 2019

(54) SMART COOKING APPARATUS

(71) Applicant: Walmart Apollo, LLC, Bentonville, AR (US)

(72) Inventors: Greg A. Bryan, Bentonville, AR (US); Brian Charlesworth, Bentonville, AR (US); David G. Tovey, Rogers, AR (US); Eric Letson, Bentonville, AR (US); Kurt William Robert Bessel, Mexico, NY (US)

(21) Appl. No.: 16/381,693

(22) Filed: Apr. 11, 2019

Related U.S. Application Data
(60) Provisional application No. 62/657,328, filed on Apr. 13, 2018.

(51) Int. Cl. A47J 27/00; G10L 15/22

(52) U.S. Cl. CPC A47J 27/004; G10L 2015/223; G10L 15/22

(57) ABSTRACT

A cooking apparatus is presented. The cooking apparatus includes multiple independently controlled food preparation zones. The cooking apparatus further includes a network interface and a scanning device integrated into the cooking apparatus and configured to read a machine-readable identifier of a meal kit. The cooking apparatus additionally includes a processor in communication with each of the food preparation zones and that independently controls a temperature and time of food preparation in each of the food preparation zones in accordance with a set of cooking instructions retrieved via the network interface using the machine-readable identifier.

### CROSS-REFERENCE TO RELATED PATENT APPLICATIONS

This application claims priority to U.S. Provisional Application No. 62/657,328, filed on Apr. 13, 2018, the content of which is hereby incorporated by reference in its entirety.

### BACKGROUND

A slow cooker device, such as a crock pot, typically includes a cooking vessel or “crock” made of glazed ceramic or porcelain that is surrounded by a housing containing an electric heating element and a set of controls. The typical crock pot provides a single cooking zone wherein food items are cooked at a set temperature for a period of time. Crock pots usually include a stoneware or ceramic vessel for holding the food. The stoneware cooking vessel is removably insertable into a housing. The housing includes a metallic basin or dish which follows the outer contours of the stoneware or ceramic vessel so that when the crock pot is activated, the heat will evenly distribute over the surface of the stoneware. Another popular device is an instant pot, which is a multi-cooker that does the job of a slow cooker, electric pressure cooker, rice cooker, steamer, yogurt maker, sauté/browning pan, and warming pot.

Crock pots typically rely on a slow, even rate of cooking to function. Cooking time in crock pots may be several hours. The low temperature of the cooking permits the user of the device to start cooking a meal in the morning and have it ready and properly cooked in time for dinner. Due to the slow cooking nature of the device, the contents of the cooking device need not be constantly monitored in order to prevent burning. In addition, the relatively low power and even distribution of heat of the crock pot prevents hot spots from forming in the stoneware, which could lead to thermal stresses and ultimately cracking of the stoneware. The stoneware that is used acts as an insulator which is beneficial for slow cooking and an even distribution of the heat. Crock pots allow simmering type cooking over several hours.

### SUMMARY

While crock pots are very popular, they are typically limited in that they can only be used to heat/cook a food item at a set temperature for a set period of time. Everything in the crock pot is heated together and cooked for a same amount of time, with no differentiating between the different food items or cooking the different food items at different times or at different temperatures. To address these limitations of conventional crock pots, in one embodiment, a smart cooking apparatus includes multiple temperature zones for food preparation that are automatically controlled. The smart cooking apparatus includes a scanning element that is configured to read a machine-readable identifier on a meal kit liner. The smart cooking apparatus also includes a network communication interface that enables it to connect to a recipe database to retrieve cooking instructions for the meal kit using the scanned identifier. The different food preparation zones allow the device to cook different food items within a meal kit at different temperatures and times to achieve a meal on schedule.

### BRIEF DESCRIPTION OF THE DRAWINGS

The accompanying drawings, which are incorporated in and constitute a part of this specification, illustrate one or more embodiments of the invention and, together with the description, help to explain the invention. The drawings are not necessarily to scale, or inclusive of all elements of a system, emphasis instead generally being placed upon illustrating the concepts, structures, and techniques sought to be protected herein. In the drawings:

FIG. 1 is a front view diagram of a smart cooking apparatus, according to an example embodiment.

FIG. 2 is a top view diagram of a smart cooking apparatus, according to an example embodiment.

FIG. 3 is a block diagram of a smart cooking apparatus, according to an example embodiment.

FIG. 4 is a flowchart illustrating an exemplary method for using a smart cooking apparatus, according to an example embodiment.

FIG. 5 is a diagram of an exemplary network environment suitable for a customer feedback classification implementation of exemplary embodiments.

FIG. 6 is a block diagram of an exemplary computing device that may be used to implement exemplary embodiments described herein.

### DETAILED DESCRIPTION

Embodiments of the presently disclosed smart cooking apparatus may help reduce or eliminate some of the time required for meal preparation and clean up. The entire meal may only require one pot and the user does not have to know how to cook the meal. Instead, a user can simply insert a meal kit into the smart cooking apparatus whereupon a label on the meal kit is read or scanned to automatically obtain a set of cooking instructions for the smart cooking apparatus to follow. The smart cooking apparatus controls the different temperature zones according to the retrieved instructions so that the completed meal will be ready at a designated time.

In one embodiment, a smart cooking apparatus includes multiple temperature zones and controls which are independently controllable by a processor in the smart cooking apparatus. Meals are packaged for cooking in the smart cooking apparatus in a meal liner kit. The meal liner kit includes segmented areas dividing the different portions of the meal and a machine-readable ID linked to instructions for cooking the meal contained in the meal liner kit. A scanning element in the smart cooking apparatus is configured to read the machine-readable identifier. Once the machine-readable identifier has been read, the smart cooking apparatus uses a network communication interface to connect to a network-accessible recipe database to retrieve cooking instructions associated with the particular meal kit. Using the retrieved instructions, the smart cooking apparatus can cook different food items at different temperatures and times to achieve a fully cooked meal that is ready at a particular time.

The smart cooking apparatus has separately controllable food preparation zones for different sections of the base of the apparatus. In more detail, the base includes separately controllable heating elements in each food preparation zone that may be activated via a command from the processor (pursuant to the retrieved instructions) to heat and/or defrost an adjacent portion of a meal kit. In one embodiment, each food preparation zone may also include a cooling element that can be used to provide refrigeration capability to the adjacent portion of the meal kit. For example, the cooling element may, in one non-limiting example, include a coil through which Freon may be controllably dispensed in order to lower a temperature of just one adjacent portion of a meal kit. The meal kits are packaged in a cooking liner and may also be divided into segments of different types of ingredients (meat, starch, vegetables, etc.). The meal kit segments may be oriented vertically, horizontally or both, such that a segment is aligned with a heating/refrigeration zone.

In one embodiment the liner is disposable. In another embodiment, the liner may be a reusable type of container that is maintained throughout the cooking process.

In one embodiment in which the smart cooking apparatus includes cooling elements, the smart cooking apparatus can maintain a cold state of an adjacent portion of the meal kit for a period of time. This serves to keep food fresh until it begins cooking. The smart cooking apparatus can also be used to defrost a frozen meal kit before cooking. Accordingly, the smart cooking apparatus can maintain the cooked meal at a safe temperature until the meal is served. The meal kit may also have a permeable barrier between segments, allowing flavors from food in one segment to be shared with food in another segment

In one embodiment, the smart cooking apparatus includes a non-symmetrical internal shape which will allow a packaged meal kit to be inserted with a specific orientation. Further, in a particular embodiment, the sides of the smart cooking apparatus may also taper in to help with kit alignment. This allows the smart cooking apparatus to heat or cool the different sections of the meal kit to optimum temperature for the specific recipe. In certain embodiments, the smart cooking apparatus can be controlled through electronic means (Wireless Fidelity (WIFI) or the like) via electronic assistants like Google Voice®, Alexa® or others, or directly via voice commands using a built-in speech synthesizer.

In one embodiment, to operate the smart cooking apparatus, the user takes the meal kit and places it in the smart cooking apparatus. The smart cooking apparatus uses its scanning element to read a code or label on the outside of the meal kit package to retrieve an identifier. The user may provide a completion time via voice command, through a manual control, or may confirm the preferred time announced.

In an embodiment, a user can customize the meal by indicating their preference for certain cooking characteristics (e.g., rare, medium, well-done, crunchy) that relate to cooking time and the smart cooking apparatus adjusts the cooking instructions accordingly based on pre-defined amounts of time associated with the requested adjustment.

In one embodiment, a spice level for the meal may be altered by the smart cooking apparatus by either puncturing or not puncturing all of the spice packages provided in the meal kit. In one embodiment, a spice control mechanism features a spice reservoir which the machine can draw upon and dispense to the meal kit to provide the desired spice level for the user.

In an embodiment, WIFI or remote voice assistant communications may be used by the customer to alter the finish cooking time of the meal remotely (e.g. indicating that a finish time was previously 6:30 and the new time should be 7:30). The customer may also remotely monitor the cooking progress through an application on a smart device.

As noted above, the meal kit liner will feature a machine-readable identifier on the outside of the liner. Instructions associated with the identifier provide the temperature/time cycle to the cooking device (multiple cook cycles may be provided to allow a customer to customize the meal by cooking until extra tender, al dente, etc.) Spice packages may also be provided with the meal kit to allow the customer to choose their level of spice. In one embodiment, the smart cooking apparatus punctures the corresponding number of spice packages to provide a desired spiciness level. (e.g.: if the meal kit contains five spice packages and the user desires three alarm chili, the smart cooking apparatus may puncture three spice packages)

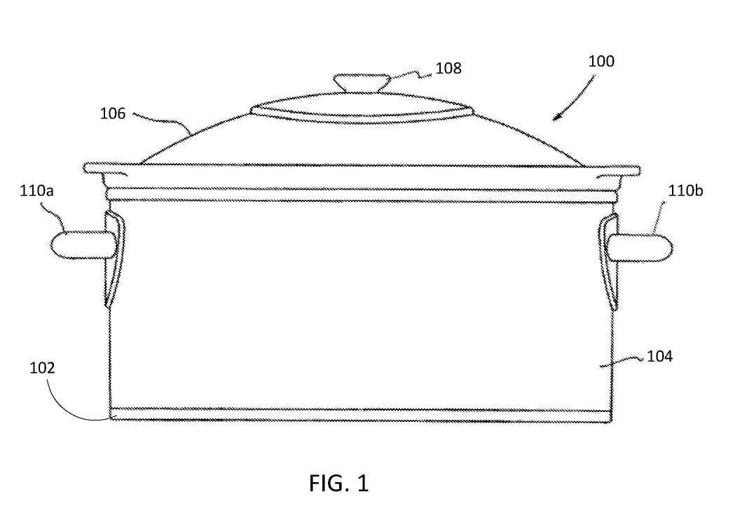

FIG. 1 is a diagram showing a smart cooking apparatus 100 according to an example embodiment. The smart cooking apparatus 100 includes a base 102 and a sidewall 104. The base and sidewall define an area within for heating a meal. Also shown is a cover 106 having a cover handle 108. Additionally shown are side handles 110a and 110b.

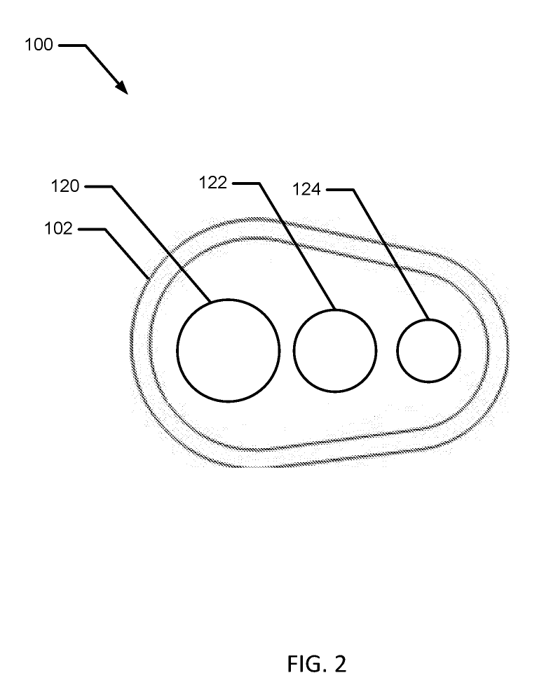

FIG. 2 depicts a top view of an example smart cooking apparatus 100. The smart cooking apparatus has a non-symmetrical shape 102 and includes three food preparation zones 120, 122 and 124. Each food preparation zone includes heating and/or cooling elements that are independently controllable by the processor in the smart cooking apparatus. For example, food preparation zone 120 may be set at one temperature for heating a segment of a meal kit while food preparation zone 122 may be off or set at a different temperature for a different segment of the meal kit.

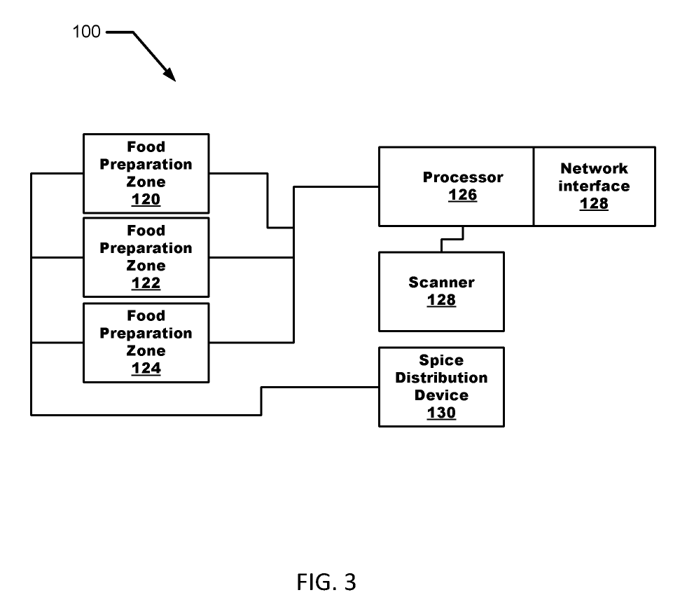

FIG. 3 shows a block diagram of some of the components of the smart cooking apparatus 100. In this embodiment there are three food preparation zones 120, 122 and 124. Each food preparation zone 120, 122 and 124 is independently controlled by processor 126 via its own heating and/or cooling element (not shown). Processor 126 is in communication with each food preparation zone 120, 122 and 124 and with scanner 128. Processor 126 includes a network interface 128. A spice distribution device 130, controlled by processor 126, is also in communication with each food preparation zone and is configured to interact with the meal kit so as to dispense spices associated with the particular meal kit.

In one non-limiting example, a meal kit has three segments. It should be understood that a meal kit could include any number of segments. A first segment of the meal kit includes a protein, such as chicken. A second segment of the meal kit includes a starch, such as rice. The third segment of the meal kit includes a vegetable such as green beans. Each segment needs to be cooked at a different temperature, for a different period of time, and therefore begin cooking at a different time, in order to provide a fully cooked meal at a desired time. The meal kit label or other machine-readable identifier is read by a scanning element of the smart cooking apparatus to retrieve cooking instructions associated with the meal kit. The meal kit is inserted in the crock pot in a particular orientation, such that a particular segment is aligned with a particular food preparation zone. In this example, the first segment of the meal kit is aligned with the first food preparation zone, the second segment of the meal kit is aligned with the second food preparation zone, and the third segment of the meal kit is aligned with the third food preparation zone. In one embodiment, the meal kit liner shape corresponds to that of the asymmetrical base of the smart cooking apparatus such that only one alignment is possible. The smart cooking apparatus accesses a database over a network to obtain the cooking instructions for the meal kit based on the scanned information. In this example, the chicken needs to cook for three hours at a high temperature, the rice for one hour and a medium temperature and the green beans for one half an hour at a low temperature. A desired time for the finished meal is determined to be 6:00.

In accordance with the cooking instructions, the smart cooking apparatus starts cooking the chicken in the first segment at 3:00 while maintain the other segments as they are, either at room temperature or at a refrigerated temperature in order to help preserve the freshness of the meal kit components that are not being heated at this time. At 5:00 the second zone is activated to heat the rice in the second segment. The first zone continues cooking the chicken in the first segment, while the green beans in the third segment are kept refrigerated. At 5:30, the third zone is activated to begin heating the green beans. The first zone continues cooking the chicken in the first segment, and the second zone continues heating the rice. At 6:00 the entire meal of chicken, rice and green beans is ready. Should the user decide to change the meal ready time from 6:00 to 7:00 for example, either the cooking times of each zone would be delayed an hour, or if the cooking process has already started, the food in each segment will simmer for an hour.

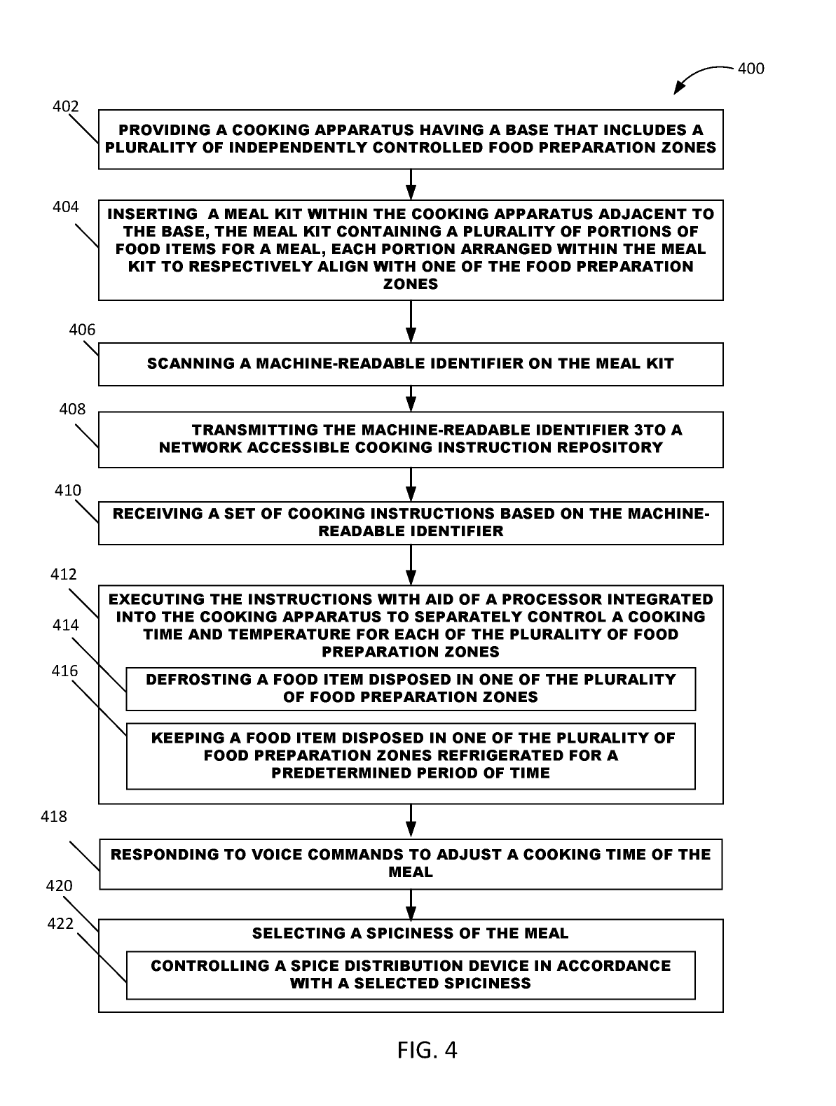

FIG. 4 is a flow diagram showing illustrative processing that can be implemented for cooking a meal with a smart cooking apparatus in an exemplary embodiment. The depicted steps represent computer software instructions or groups of instructions performing the described functionality. Alternatively, the steps may be performed by functionally equivalent circuits such as a digital signal processor (DSP) circuit or an application specific integrated circuit (ASIC). The flow diagrams do not depict the syntax of any particular programming language but rather illustrate the functional information one of ordinary skill in the art requires to fabricate circuits or to generate computer software to perform the processing required of the particular apparatus. It should be noted that many routine program elements, such as initialization of loops and variables and the use of temporary variables may be omitted for clarity. The particular sequence of steps described is illustrative only and can be varied without departing from the spirit of the concepts, structures, and techniques sought to be protected herein. Thus, unless otherwise stated, the steps described below are unordered meaning that, when possible, the functions represented by the blocks can be performed in any convenient or desirable order.

Referring to FIG. 4, a flowchart illustrating an exemplary method 400 for operating a smart cooking apparatus is shown. The method begins with providing a cooking apparatus having a base that includes a plurality of independently controlled food preparation zones (step 402). The next step involves inserting a meal kit within the cooking apparatus adjacent to the base, the meal kit containing a plurality of portions of food items for a meal, each portion arranged within the meal kit to respectively align with one of the food preparation zones upon the meal kit being inserted into the cooking apparatus(step 404). The food preparation zones can be associated with a specific ingredient of the meal kit. For example, a first zone may be used for cooking a protein, a second zone for cooking a vegetable and a third zone for cooking a starch. The meal kit is inserted such that different food preparation zones align with different segments of the meal kit. The smart cooking apparatus may have a non-uniform shape such that the meal kit can only be inserted in one orientation. This will help ensure that the meal kit segments are aligned with the appropriate food preparation zone. The different food preparation zones of the smart cooking apparatus can be independently controlled to provide a fully cooked meal at a desired time.

The next step entails scanning a machine-readable identifier on the meal kit with a scanning device integrated into the cooking apparatus and transmitting the machine-readable identifier via a network communication interface to a network accessible cooking instruction repository (steps 406 and 408).

The next step includes receiving a set of cooking instructions based on the machine-readable identifier, and executing the instructions with aid of a processor integrated into the cooking apparatus to separately control a cooking time and temperature for each of the plurality of food preparation zones (steps 410 and 412).

The next step includes keeping a food item disposed in one of the plurality of food preparation zones refrigerated for a predetermined period of time and defrosting a food item disposed in one of the plurality of food preparation zones (steps 414 and 416). This can be used to keep food cold and fresh until it is time to begin cooking the food item. If the meal kit was stored in a freezer, then a defrosting of a food item may be required.

The following step shows responding to voice commands to adjust a cooking time of the meal (step 418). This can be done to adjust the doneness of the meal by cooking until extra tender, al dente, etc. Additionally, if the planned finish time for the meal has changed, the finish cooking time of the meal can be changed accordingly (e.g., the finish time was 6:30, new time 7:30). Alternately, if the cooking process has already been stared, the smart cooking apparatus can be controlled to simmer the food items until the desired finish time is reached.

The next step involves selecting a spiciness of a meal and controlling a spice distribution device in accordance with a selected spiciness (step 420 and step 422). In one embodiment, a spice control mechanism features a spice reservoir which the machine can draw upon to provide the desired spice level for the user. In another embodiment, spice packets are provided with the meal kit, and the spice distribution device punctures the appropriate number of spice packets. For example, a spice level of 1 to 5 can be provided. With each level associated with an individual spice packet inside the segment. The user has selected a 3 for the spice level. In this case, only 3 of the 5 spice packets would be punctured.

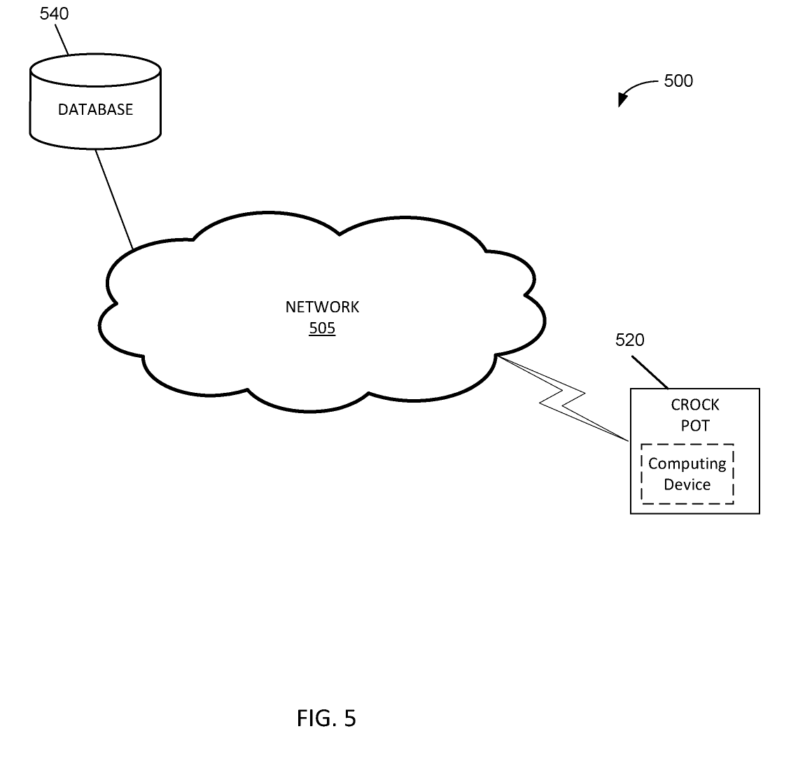

FIG. 5 illustrates a network diagram depicting a system 500 for implementing the smart cooking apparatus system, according to an example embodiment. The system 500 can include a network 505, a smart cooking apparatus 520 including a computing device, and a database 540. The smart cooking apparatus 520 and database 540 are in communication with the network 505.

In an example embodiment, one or more portions of network 505 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The smart cooking apparatus 520 may connect to network 505 via a wired or wireless connection. In an example embodiment, the smart cooking apparatus 520 may transmit data or signals to database 540. The database 540 comprises one or more storage devices for storing data and/or instructions (or code) for use by the smart cooking apparatus 520.

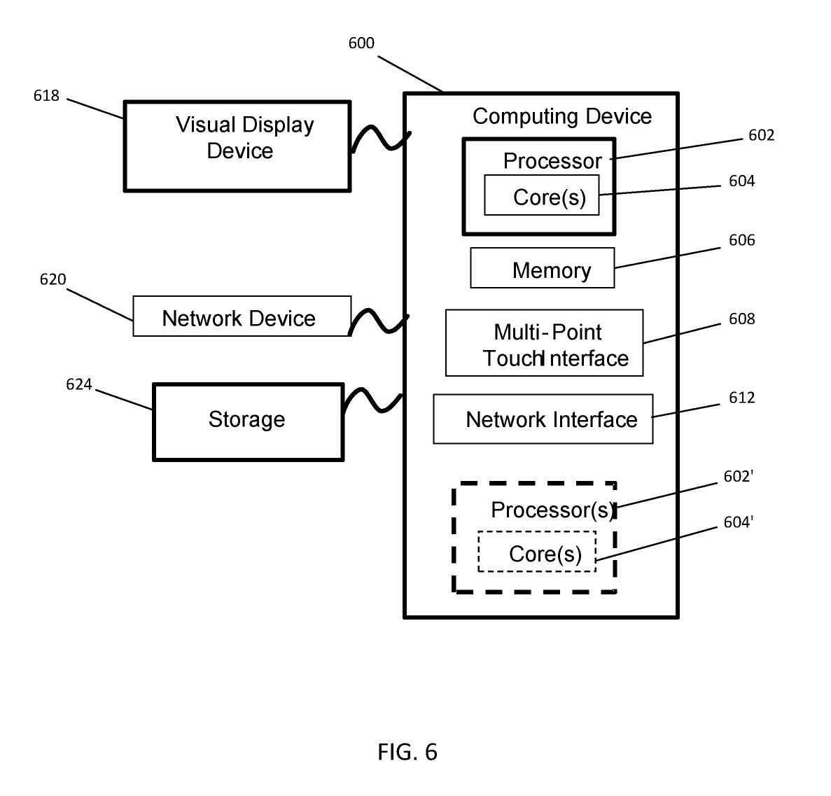

FIG. 6 is a block diagram of an exemplary computing device 600 that may be included as part of the crockpot. The computing device 600 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 606 included in the computing device 600 can store computer-readable and computer-executable instructions or software for implementing exemplary embodiments. The computing device 600 also includes processor 602 and associated core 604, and optionally, one or more additional processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ can each be a single core processor or multiple core (604 and 604′) processor.

Memory 606 can include a computer system memory or random access memory, such as DRAM, SRAM, EDO RAM, and the like. Memory 606 can include other types of memory as well, or combinations thereof. An individual can interact with the computing device 600 through a visual display device 618, such as a touch screen display or computer monitor, which can display one or more user interfaces for receiving data from the individual (e.g., order data and travel data). The visual display device 618 can also display other aspects, elements and/or information or data associated with exemplary embodiments. The computing device 600 can include other I/O devices for receiving input from an individual

The computing device 600 can also include one or more storage devices 624, such as a hard-drive, CD-ROM, or other computer readable media, for storing data and computer-readable instructions and/or software, such as one or more modules of the system that implements exemplary embodiments as described herein. Exemplary storage device 624 can also store one or more databases for storing suitable information required to implement exemplary embodiments. The databases can be updated by an individual or automatically at a suitable time to add, delete or update one or more items in the databases.

The computing device 600 can include a network interface 612 configured to interface via one or more network devices 620 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or another device suitable for interfacing the computing device 600 to a type of network capable of communication and performing the operations described herein.

The description is presented to enable a person skilled in the art to create and use a computer system configuration and related method and systems for dynamic delivery scheduling. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts have been provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that the scope of protection sought herein should not be limited to the described embodiments but rather should be limited only by the spirit and scope of the following claims.

What is claimed is:

1. A cooking apparatus with network communication capability, comprising:
at least one side wall;
a base physically connected to the at least one side wall, the base including a plurality of food preparation zones;
a network interface;
a scanner located on at least one of the base and at least one side wall and configured to read a machine-readable identifier of a meal kit; and
a processor in communication with each of the first, second and third food preparation zones and wherein the processor is configured to independently control a temperature and time of food preparation in each of the food preparation zones in accordance with a set of cooking instructions retrieved via the network interface using the machine-readable identifier.

2. The cooking apparatus of claim 1, wherein the base is configured to accept a meal kit such that different food preparation zones align with different segments of the meal kit.

3. The cooking apparatus of claim 1, wherein the cooking area within the base has a non-symmetrical internal shape.

4. The cooking apparatus of claim 1, wherein a food preparation zone is controllable to keep a food item disposed therein refrigerated for a predetermined period of time.

5. The cooking apparatus of claim 1, wherein a food preparation zone is controllable to defrost a food item disposed therein.

6. The cooking apparatus of claim 1, wherein the processor is configured to execute instructions from a user received via a voice command.

7. The cooking apparatus of claim 6, wherein the processor is configured to execute instructions from a user received via a voice command to alter a cooking time of the meal kit.

8. The cooking apparatus of claim 1, further comprising a spice distribution device disposed therein.

9. The cooking apparatus of claim 8, wherein the spice distribution device includes an element for puncturing a spice packet within a meal kit.

10. The cooking apparatus of claim 8, wherein the spice distribution device comprises a spice reservoir controllable in accordance with the cooking instructions.

11. A method of using a cooking apparatus with network communication capability, the method comprising:
providing a cooking apparatus having a base that includes a plurality of independently controlled food preparation zones;
inserting a meal kit within the cooking apparatus adjacent to the base, the meal kit containing a plurality of portions of food items for a meal, each portion arranged within the meal kit to respectively align with one of the food preparation zones upon the meal kit being inserted into the cooking apparatus;
scanning a machine-readable identifier on the meal kit with a scanning device integrated into the cooking apparatus;
transmitting the machine-readable identifier via a network communication interface to a network accessible cooking instruction repository;
receiving a set of cooking instructions based on the machine-readable identifier; and
executing the instructions with aid of a processor integrated into the cooking apparatus to separately control a cooking time and temperature for each of the plurality of food preparation zones.

12. The method of claim 11, further comprising responding to voice commands to adjust a cooking time of the meal.

13. The method of claim 11, further comprising selecting a spiciness of a meal.

14. The method of claim 13, further comprising controlling a spice distribution device in accordance with a selected spiciness.

15. The method of claim 11, further comprising keeping a food item disposed in one of the plurality of food preparation zones refrigerated for a predetermined period of time.

16. The method of claim 11, further comprising defrosting a food item disposed in one of the plurality of food preparation zones.

17. The method of claim 11, wherein each food preparation zone is controlled to provide a completely cooked meal at a predetermined time.

18. A non-transitory machine-readable medium storing instructions executable by a processing device of a cooking apparatus, wherein execution of the instructions causes the processing device to:
scan a machine-readable identifier on a meal kit with a scanning device integrated into the cooking apparatus;
transmit the machine-readable identifier via a network communication interface to a network accessible cooking instruction repository;
receive a set of cooking instructions based on the machine-readable identifier; and
execute the cooking instructions with aid of a processor integrated into the cooking apparatus to separately control a cooking time and temperature for each of a plurality of food preparation zones.

19. The non-transitory machine-readable medium of claim 18, further comprising instructions causing the processing device to keep a food item disposed in one of the plurality of food preparation zones refrigerated for a predetermined period of time.

20. The non-transitory machine-readable medium of claim 18, further comprising instructions wherein each food preparation zone is controlled to provide a completely cooked meal at a predetermined time.
